(19) United States
(12) Patent Application Publication
(10) Pub. No.: US 2019/0372113 A1
(43) Pub. Date: Dec. 5, 2019

(54) Porous-Carbon-Coated Sulfur Particles and Their Preparation and Use

(71) Applicants: Ihab Nizar ODEH, Sugar Land, TX (US); SABIC Global Technologies B.V., Bergen op Zoom (NL)

(72) Inventors: Ihab Nizar Odeh, Sugar Land, TX (US); Yuming Xie, Lexington, KY (US); Heli Wang, Sugar Land, TX (US); Ganesh Kannan, Sugar Land, TX (US)

(21) Appl. No.: 16/481,556

(22) PCT Filed: Jan. 30, 2018
(86) PCT No.: PCT/US2018/015889

§ 371 Date: Jul. 29, 2019

Related U.S. Application Data
(60) Provisional application No. 62/451,982, filed on Jan. 30, 2017.

(51) Int. Cl. H01M 4/36; H01M 4/58; H01M 4/38; H01M 4/587; H01M 10/052

(52) U.S. Cl. CPC H01M 4/366; H01M 4/5815; H01M 2004/021; H01M 4/587; H01M 10/052; H01M 4/38

(57) ABSTRACT

A sulfur-containing composition is formed from a sulfur particle and a continuous porous carbon coating surrounding the sulfur particle. The porous carbon coating has a uniform or nearly uniform thickness of 1 nm to 10 μm and an average pore size 1 nm or less. In a method of forming a sulfur-containing composition a sulfur particle is contacted with at least one of 1) a polymerizable monomer material under polymerization reaction conditions sufficient to form a continuous carbonizable polymer coating on the sulfur particle surface, and 2) a dissolved carbonizable polymer that forms a carbonizable polymer coating on the sulfur particle surface. The carbonizable polymer coating is carbonized to form a porous carbon coating surrounding the sulfur particle, the porous carbon coating having a uniform or nearly uniform thickness of 1 nm to 10 μm and an average pore size 1 nm or less.

### CROSS-REFERENCE TO RELATED APPLICATIONS

This application is a national stage application under 35 U.S.C. §371 of International PCT Application No. PCT/US2018/015889, filed Jan. 30, 2018, which claims the benefit of U.S. Provisional Application No. 62/451,982, filed Jan. 30, 2017, each of which is incorporated herein by reference in its entirety.

### TECHNICAL FIELD

The invention relates to sulfur-containing compositions and their preparation and use, and in particular embodiments to those sulfur-containing compositions that may be used in energy storage devices.

### BACKGROUND

High energy storage capacity and high energy density rechargeable batteries are among the highly sought after technologies for portable electronic devices and electric vehicles. Lithium-sulfur batteries are among the best candidates for these applications for several reasons. The sulfur cathode of these batteries has a high theoretical capacity of 1672 mAhg⁻¹, which is about five times that of currently used transition metal oxide cathode materials for lithium batteries. Additionally, sulfur is an abundant resource that may be obtained at a low cost. Sulfur is also non-poisonous and is environmentally benign.

Lithium-sulfur electrodes have certain drawbacks, however, so that they have not yet been commercialized. For one, sulfur has extremely low electrical conductivity at 5=10⁻³⁰ S/cm at 25° C. Further, the migration of polysulfides into the electrolyte of the battery affects the battery's cycle life. Volume changes during the charge-discharge cycle also affect the mechanical and electrochemical integrity of the lithium-sulfur electrode.

Accordingly, a need exists for improvements to such lithium-sulfide electrodes to overcome these shortcomings.

### SUMMARY

A sulfur-containing composition includes a sulfur particle and a continuous porous carbon coating surrounding the sulfur particle. The porous carbon coating has a uniform or nearly uniform thickness of 1 nm to 10 μm and an average pore size 1 nm or less.

In specific embodiments, the sulfur particle comprises at least one of a metal sulfide, a metal polysulfide, and elemental sulfur. The sulfur particle may have a particle size of from 0.001 micron to 10 microns. The porous carbon coating may have an average pore size of from 0.7 nm or less. In other embodiments, the porous carbon coating may have an average pore size of from 0.1 nm to 0.7 nm, and in still other embodiments, the porous carbon coating may have an average pore size of from 0.3 nm to 0.6 nm.

In particular embodiments, the porous carbon coating is present in an amount of from 1 wt. % to 90 wt. % of the total weight of the coated sulfur particle. The porous carbon coating may have a uniform or nearly uniform thickness of from 1 nm to 1 μm. The porous carbon coating may also include a dopant to increase the electrical conductivity of the porous carbon coating.

In certain applications, the porous-carbon-coated sulfur particle is incorporated into an energy storage device.

In a method of forming a sulfur-containing composition, a sulfur particle is contacted with at least one of 1) a polymerizable monomer material under polymerization reaction conditions sufficient to form a continuous carbonizable polymer coating on the sulfur particle surface, and 2) a dissolved carbonizable polymer that forms a carbonizable polymer coating on the sulfur particle surface. The carbonizable polymer coating is carbonized to form a porous carbon coating surrounding the sulfur particle, with the porous carbon coating having a uniform or nearly uniform thickness of 1 nm to 10 μm and an average pore size 1 nm or less.

In specific embodiments of the method, the sulfur particle comprises at least one of a metal sulfide, a metal polysulfide, and elemental sulfur. The porous carbon coating may have an average pore size of from 0.1 nm to 0.7 nm. In certain embodiments, the porous carbon coating may be present in an amount of from 1 to 90 wt. % of the total weight of the coated sulfur particle.

In certain applications, the porous-carbon-coated sulfur particle is incorporated into an electrical energy storage device or an electrode for an energy storage device.

In particular embodiments, the polymerizable monomer material is selected from at least one of 4-vinylpyridine, divinylbenzene, vinylidene chloride, styrene, methylmethoacrylate, aniline, epoxide, urethanes, acrylates, and furfuryl alcohol.

The carbonizable polymer coating may be doped to increase the electrical conductivity of the porous carbon coating during at least one of 1) the formation of the carbonizable polymer coating and 2) carbonizing the carbonizable polymer coating. In specific instances, the carbonizable polymer coating is carbonized in a substantially oxygen-free atmosphere to form a porous carbon coating surrounding the sulfur particle.

In certain embodiments of the method, the porous carbon coating has a uniform or nearly uniform thickness of from 1 nm to 1 μm.

### DETAILED DESCRIPTION

In lithium-sulfide batteries, during discharge of the battery, lithium metal plated on the anode is oxidized to lithium ions and electrons, the lithium ions pass through the electrolyte of the battery cell to the sulfur-containing cathode where lithium ions react with the sulfur to form lithium polysulfide, where two lithium atoms are bonded to the polysulfide molecule. Where the polysulfide is S₈, for example, this may be represented by the reaction (A) below:

S₈+2Li→Li₂S₈ (A)

The reaction may continue with the Li₂S₈ reacting further with additional lithium, as shown in reaction (B) below:

Li₂S₈+2Li→Li₂S₈₋ₓ+Li₂Sₓ, where x=2 to 7 (B)

With more lithium being drawn to the cathode during discharge, the length of the lithium polysulfide chains will decrease, ultimately being reduced to Li₂S, as shown in the exemplary reaction (C) below:

Li₂S₂+2Li→2Li₂S (C)

Charging of the battery reverses this process so that lithium atoms from the lithium sulfide or polysulfides are plated back on the anode as metal, as represented by the exemplary reactions (D) and (E) below:

Li₂Sₓ+Li₂S→Li₂S_{1+y}+2Li, where y=1 to 7 (D)

Li₂Sₙ→Sₙ+2Li, where n=1, to 8, 12,etc. (E)

One of the degrading mechanisms of lithium-sulfide batteries during charge-discharge cycles is the dissolution of polysulfide ions from the cathode to the anode. In lithium-sulfur batteries, the polysulfide ions are predominantly S₄^{m-}—S₈^{m-} (with m usually equal to 2). The polysulfide ions are easily moved around when subjected to an electric field and are prone to dissolve in the organic electrolyte [for Sₙ, (n>4)] and diffuse from the cathode to the anode where the polysulfide deposits on the anode. The ionic organic electrolyte is designed to be less soluble for smaller polysulfides (up to S₄). The loss of sulfur from the cathode of the battery is permanent, so power density and charge capacity drop with increased number of cycles as the sulfur is gradually lost. In order to physically prevent the dissolution of the S₄ⁿ⁻—S₈ⁿ⁻ into the electrolyte, a diffusion barrier must be provided on the cathode. In an ideal case, a conductive cage would physically contain the sulfur inside while providing pathways for the smaller lithium ions and electrons to pass through, retaining the sulfur within the cage.

The sulfur particle size used on the cathode must be relatively small so that the electron and lithium ion transport can proceed within a short distance to facilitate a rapid rate of charging and discharging. The S₆ⁿ⁻—S₈ⁿ⁻ polysulfide ions have a size of 0.7 nm or more. Thus, porous carbon provides an ideal media for such purposes if the pore size can be kept below 0.7 nm.

While nanoporous carbon materials have been developed for use with lithium-sulfide materials, these materials typically have had average pore sizes of from 2-4 nm or greater, with a pore size distribution at the 99the percentile (d₉₉) at 9 nm or in the range of 3.6 to 5.4 nm as a single crystal. Such pore sizes are significantly larger than the critical size of 0.7 nm for S₄ⁿ⁻—S₈ⁿ⁻ polysulfide ions such that the polysulfide ions will still tend to migrate into the electrolyte solution and be deposited on the anode, thus reducing the battery's cycle life.

In embodiments of the present invention, a porous carbon coating can be provided on a sulfur material, such as may be used for or in the formation of the cathode material of a lithium-sulfide battery, wherein the porous carbon coating has a uniform or nearly uniform thickness of from 1 nm to 10 μm, and an average pore size of from 1 nm or less. In specific embodiments, the porous carbon coating may have uniform or nearly uniform thickness of from 10 nm to 1 μm and an average pore size of from 0.7 nm or less or less than 0.7 nm. In particular embodiments, the porous carbon coating may have an average pore size of from 0.2 nm, 0.3 nm or 0.4 nm to 0.6 nm, 0.7 nm, 0.8 nm, 0.9 nm, or 1 nm. In certain embodiments, the porous carbon coating may have an average pore size of from 0.3 nm to 0.7 nm, from 0.3 nm to less than 0.7 nm, or from 0.4 nm to 0.6 nm. As used herein, average pore size is that pore size for the porous carbon coating as measured by N₂ adsorption/desorption. Thus, the pore sizes are those that can significantly reduce or prevent the migration of the Sₙm⁻ (where n >4) polysulfide ions as compared with carbon coatings have larger average pore sizes.

It should be noted in the description, if a numerical value, concentration or range is presented, each numerical value should be read once as modified by the term “about” (unless already expressly so modified), and then read again as not so modified unless otherwise indicated in context. Also, in the description, it should be understood that an amount range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific points within the range, or even no point within the range, are explicitly identified or refer to, it is to be understood that the inventor appreciates and understands that any and all points within the range are to be considered to have been specified, and that inventor possesses the entire range and all points within the range.

To provide the porous carbon coating an initial polymer coating is provided on a sulfur particle or sulfur-containing particle. The sulfur particle may include elemental sulfur. Elemental sulfur can include, but is not limited to, all allotropes of sulfur (i.e., Sₙ where n=1 to ∞). Non-limiting examples of sulfur allotropes include S, S₂, S₄, S₆, S₈, S₁₀, and S₁₂ with the most common allotrope being Ss. The sulfur particle may also be a metal sulfide. In particular embodiments, a lithium (Li) metal sulfide is used. This may include a fully lithiated sulfur, i.e., Li₂S, or a lithium polysulfide, such as Li₂S₂, where n is from 2 to 12. In most instances, where a lithium polysulfide is used as the sulfur particle, n will range from 2 to 8.

While a lithium metal sulfide may be used as the sulfur particle, in certain instances, the metal of the metal sulfide can be a non-lithium transition metal of the Periodic Table. In particular, non-limiting examples of such transition metals include iron (Fe), silver (Ag), copper (Cu), nickel (Ni), zinc (Zn), manganese (Mn), cobalt (Co), lead (Pb), or cadmium (Cd), or Tin (Sn). Non-limiting examples of non-lithium metal sulfides include ZnS, CuS, MnS, FeS, CoS, NiS, PbS, Ag₂S, or CdS, SnS₂ or any combination thereof. Non-lithium metal polysulfides may also be used. These may include ZnSₙ, CuSₙ, MnSₙ, FeSₙ, CoSₙ, NiSₙ, PbSₙ, Ag₂Sₙ, CdSₙ, or SnSₙ, where n=2 to 12.

Combinations of the aforementioned sulfur or sulfur-containing materials may also be used. This may include combinations of elemental sulfur and metal sulfide materials. When such combinations are used, the amount of the elemental sulfur may range from 1 wt. % to 99 wt % by total weight of the sulfur-containing constituents of the sulfur particle. In other combinations, the amount of metal sulfide or metal polysulfide may range from 1 wt. % to 99 wt. % by total weight of the sulfur-containing constituents of the sulfur particle. In certain instances, the metal sulfide or metal polysulfide material may be used in an amount greater than 99 wt. % by total weight of the sulfur-containing constituents of the sulfur particle

In certain embodiments, a sulfur particle is used that is comprised primarily or entirely of fully lithiated sulfur (Li₂S). In such instances, the sulfur particle may contain Li₂S in an amount of from 50 wt. %, 55 wt. %, 60 wt. %, 65 wt. %, 70 wt. %, 75 wt. %, 80 wt. %, 95 wt. %, 96 wt. %, 97 wt. %, 98 wt. %, 99 wt. % or greater by total weight of the sulfur-containing constituents of the sulfur particle. The remainder of the sulfur-containing constituents may be elemental sulfur, lithium polysulfides (e.g., Li₂Sᵣ, where n>1), or combinations of these materials. In certain instances, non-lithium metal sulfides may also make up the remainder or some portion of the remainder.

Fully lithiated sulfur has a greater volume than elemental sulfur or lithium polysulfides. By using a sulfur particle that is primarily or entirely formed from fully lithiated sulfur, the porous carbon coating formed around such a particle forms a core-shell structure that is at its greatest volume and wherein the porous carbon coating contacts all or a substantial portion of the sulfur particle core with very little void spaces. Upon charging of the battery, the volume of the sulfur particle core of the cathode is reduced as lithium is removed from the cathode and plated to the anode, so that the porous-carbon-coated sulfur particle becomes a yolk-shell structure, where portions of the sulfur particle core do not contact the porous carbon coating and there are void spaces present within porous-carbon-coated particle. During discharge of the battery, lithium is added back to the cathode so that the volume of the sulfur core increases. The volume expansion of the sulfur core may be as much as 30% to 40% in many instances. In instances where the porous carbon coating or shell is formed on a fully lithiated sulfur particle, the shell will be at its maximum volume so that there is no danger of the porous shell or coating rupturing during such expansion. This facilitates maintaining the physical integrity of the coated sulfur particles or cathode during the charge-discharge cycles.

In certain embodiments, electrically conductive materials may be incorporated into the sulfur particle itself. Such materials may increase electron conduction. Examples of such electrically conductive materials may include carbon nanotubes, carbon nanofibers, carbon nanoparticles, graphene, or other carbon materials. These materials incorporated within the sulfur particle are distinguished from the carbon coating that surrounds the sulfur particles, as is described herein.

In particular embodiments, the particle size of the sulfur particle or sulfur-containing particle may range from 0.01 micron to 10 microns, more particularly from 0.1 micron to 3 microns. As used herein, particle size refers to the greatest linear dimension of the particle. Sulfur particles can be formed in desired particles sizes from larger particles by crushing, milling, or other means, if necessary.

The initial polymer coating formed on the sulfur particle must have certain characteristics. It must be a carbon-containing polymer that can be carbonized in high yields so that it provides a pure or substantially pure carbon structure with the desired final pore size and retains its physical structure and integrity when formed as a coating on the sulfur particle. The carbonized polymer must also form a carbon coating that is conductive for electrons. In order to increase carbon yield, the polymer coating may be cross-linked during formation of the polymer coating or crosslinked during pyrolysis before conversion to carbon. Furthermore, the polymer coating layer may be one that closely conforms to the sulfur particle. During pyrolysis, the polymer coating layer shrinks and reduces in thickness. As an example, polyvinylidene chloride (PDVC) may exhibit as much as a 75% volume loss upon carbonization. The polymer coating should provide little or no additional stress that would subsequently yield cracks in the coating or sulfur particle. Additionally, the polymer coating should have good attachment or adherence to the sulfur particles to preserve the structural integrity of the coated particle.

The polymer coating may be formed in different ways. In one method, the sulfur particles are coated in situ by polymerizing the polymer coating on the particle surface. This may be accomplished using suspension polymerization techniques wherein the sulfur particles are suspended in a solvent. The solvent used is an organic solvent that is suitable for dissolving the polymer precursor monomers but that does not readily dissolve the resulting polymer formed. The solvent should be non-aqueous or substantially water-free to prevent any reaction of water with the hydroscopic Li-sulfur particle. The solvent may also be selected to have a boiling point above the polymer reaction initiation temperature, which is typically above 60° C., more typically from 80° C. to 150° C. Examples of suitable solvents include, but are not limited to, mineral oil, mineral spirits, saturated hydrocarbons, carbon disulfide (CS₂), toluene, xylene, chlorobenzene, etc.

The monomers are those that can be polymerized to form a polymer coating that can be carbonized to form a pure or substantially pure carbon structure with the desired final pore size and characteristics. The amount of monomer used is that that will give the desired coating thickness for the amount of sulfur particles used. To provide the desired coating thickness, in certain instances the monomer may be used in an amount of from 1 wt. % to 99 wt. % by total weight of the sulfur particle. In particular embodiments, the monomer may be used in an amount of 1.0 wt. %, 1.5 wt. %, 2.0 wt. %, 2.5 wt. %, 3.0 wt. %, 3.5 wt. %, 4.0 wt. %, 4.5 wt. %, or 5.0 wt. % to 5.5 wt. %, 6.0 wt. %, 6.5 wt. %, 7.0 wt. %, 7.5 wt. %, 8.0 wt. %, 8.5 wt. %, 9.0 wt. %, 9.5 wt. %, or 10 wt. % by total weight of the sulfur particles, more particularly from 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, or 2.0 wt. % to 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, or 3.0 wt. % by total weight of the sulfur particles.

Non-limiting examples of suitable monomers for preparing the polymer coating include vinylidene chloride, vinylidene fluoride, vinyl chloride, vinyl fluoride, divinylbenzene, styrene, divinyl pyridine, 4-vinylpyridine, methylmethoacrylate, aniline, epoxides, urethanes, acrylates, urethane acrylates, phthalates, ester-containing monomers, vinylpyrrolidone/divinylbenzene co-monomers, polyacrylonitrile, etc. In particular embodiments, vinylidene chloride is used as the monomer to produce a polyvinylidene chloride (PVDC) polymer coating on the sulfur particles. Combinations of these different monomers may be used in varying amounts from 1 wt. % to 99 wt. % by total weight of polymer forming monomers.

In certain instances, co-monomers may be used that facilitate adherence to the sulfur particle or provide other desired coating properties. The co-monomers may have an affinity to the lithium of the lithiated sulfur particle or to the sulfur of the sulfur particles, or both. This ensures that the polymer adheres to the surface of the sulfur particle. Monomers that have an affinity to the lithiated sulfur particle may include some of those monomers used for forming the polymer coating, described previously, but may be used with monomers for polymerization that do not have as great an affinity. Non-limiting examples of such monomer materials that have an affinity to the lithiated sulfur particles include 4-vinylpyridine, 2-vinylpyridine, and sulfonated monomers, such as sulfonated styrene. If used, the amount of co-monomer used with the sulfur particles may range from 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.5 wt. %, 2.0 wt. %, 2.5 wt. %, 3.0 wt. %, 3.5 wt. %, 4.0 wt. %, 4.5 wt. %, or 5.0 wt. % to 5.5 wt. %, 6.0 wt. %, 6.5 wt. %, 7.0 wt. %, 7.5 wt. %, 8.0 wt. %, 8.5 wt. %, 9.0 wt. %, 9.5 wt. %, or 10 wt. % by total weight of sulfur particles, more particularly from 0.50 wt. %, 0.55 wt. %, 0.6 wt. %, 0.65 wt. %, or 0.70 wt. % to 0.75 wt. %, 0.80 wt. %, 0.85 wt. %,0.9 wt. %, 0.95 wt. %, or 1.0 wt. % by total weight of sulfur particles.

To the sulfur particle, monomer, and optional co-monomer suspension is added a polymerization initiator. This is typically a free radical initiator that starts the polymerization reaction. Non-limiting examples of suitable initiators include benzoyl peroxide, azobisisobutyronitrile (AIBN), azobis(cyclohexanecarbonitrile), tert-butyl hydroperoxide, ammonium persulfate, sodium persulfate, potassium persulfate, aluminum chloride, titanium chloride, antimony chloride, zinc chloride, boron fluoride, lithium perchlorate, bis(diethylamino)benzophenone, ethyl 4-(dimethlyamino)benzoate, ethoxyacetophenone, hydroxyacetyophenone, phenoxyacetophenone, dimethylbenzil, benzophenone, methyl benzoylformate, diphenyliodonium nitrate, hydroxynaphthalimide triflate, trialylsulfonium hexafluorophosphpate, tert-butylanthraquinone, dimethyl (triphenylbenzoyl)phosphine oxide, methyl phenothiazine triethylene-benzyl peroxide, etc. The amount of initiator used may be from 1 wt. % to 20 wt. % by total weight of monomers, more particularly from 5 wt. % to 10 wt. % by total weight of monomers.

In certain embodiments, a dopant may be added to the suspension during the polymerization of the polymer coating. The dopant is added to increase the electrical conductivity of the resulting porous carbon coating. The dopant may include monomers that include certain elements or functional groups that are incorporated into the polymer during the polymerization process. These may include nitrogen, OH groups, COOH groups, boron, phosphorus, etc. Examples of nitrogen-containing monomers include, but are not limited to, acrylonitrile, aniline, and azide- or amine-containing monomers that can be polymerized to form polyacrylonitrile, polyaniline, and other nitrogen-containing polymers. Dopants may also be present, without the need for additional dopant material, as a result of the co-monomer selected and used in the polymerization, which were discussed previously. These may include those monomers discussed previously that are used in the polymerization that contain nitrogen or other functional groups that function as a dopant.

The polymerization reaction may be carried out with mixing or agitation of the suspension at a temperature of from 60° C. to 150° C. After the reaction is complete (e.g., 4 to 20 hours), the polymer-coated particles are separated from the solvent and dried. The polymerization may occur under pressure to keep monomers in the liquid state and so that they remain dissolved in the solvent. For example, a pressure of 1000 kPa to 2000 kPa may be used when polymerizing vinylidene chloride and similar monomers.

The polymer coating formed is in a continuous polymer coating that surrounds the sulfur particle, with the polymer coating having a uniform or nearly uniform thickness. In certain embodiments, the polymer coating thickness on the sulfur particle substrate may range from 0.01 μm, 0.05 μm, 0.10 μm, 0.15 μm, 0.20 μm, 0.25 μm, 0.30 μm, 0.35 μm, 0.40 μm, 0.45 μm, 0.50 μm, 0.55 μm, 0.60 μm, 0.65 μm, 0.70 μm, 075 μm, 0.80 μm, 0.85 μm, 0.90 μm, or 0.95 μm to 1.0 μm, 1.5 μm, 2.0 μm, 2.5 μm, 3.0 μm, 3.5 μm, 4.0 μm, 4.5 μm, 5.0 μm, 5.5 μm, 6.0 μm, 6.5 μm, 7.0 μm, 7.5 μm, 8.0 μm, 8.5 μm, 9.0 μm, or 10 μm or more, more particularly from 0.01 μm, 0.05 μm, 0.10 μm, 0.15 μm, 0.20 μm, 0.25 μm, 0.30 μm, 0.35 μm, 0.40 μm, 0.45 μm, 0.50 μm to 0.55 μm, 0.60 μm, 0.65 μm, 0.70 μm, 075 μm, 0.80 μm, 0.85 μm, 0.90 μm, 0.95 μm, 1.0 μm,1.5 μm, 2.0 μm, 2.5 μm, 3.0 μm, 3.5 μm, 4.0 μm, 4.5 μm, or 5.0 μm.

After the polymerization is complete, the polymer coated particles are separated from the solvent and dried. The polymer coated particles are then heated or carbonized in an oxygen-free or substantially oxygen-free atmosphere to a temperature sufficient to fully carbonize the polymer coating to form a porous carbon coating surrounding the sulfur particle. The use of nitrogen gas or other inert gas, which may be a flowing gas, may be used to provide the oxygen-free atmosphere. Heating may also be conducted in a vacuum to provide the oxygen-free atmosphere. Suitable heating temperatures may range from 500° C. to 900° C., with from 600° C. to 800° C. being used in certain instance. Heating times may range from one hour or more (e.g., 4 hours).

In certain cases, the dopant may be formed by subjecting the coated particles to plasma or gamma radiation during or after the carbonization step. In such cases, N₂, NH₃ or other gases containing the desire functional groups are introduced into the carbon coating so that the resulting carbon coating is a doped carbon coating. For instance, nitrogen plasma can be applied by introducing N₂ or NH₃ as plasma source gas. In the plasma assisted nitrogen doping process, the coated particles are put into the target plasma chamber and then negatively biased (e.g., from −1V to −2000V) and/or heated (e.g., from 50° C. to 800° C.). The plasma particles from the plasma gun will penetrate into the carbon coating due to the electric field between the target and the gun. The doping density can be tuned by justify the RF power (which generates the plasma), gas flow rate, bias, heating temperature and duration.

After the heating or carbonization step, with any optional radiation or plasma treatment, the resulting material is a sulfur particle having a continuous porous carbon coating surrounding the sulfur particle, with the porous carbon coating having a uniform or nearly uniform thickness of from 1 nm to 10 μm. In particular embodiments, the porous carbon coating may have a uniform or nearly uniform thickness that ranges from 1 nm, 2 nm, 3 nm, 4 nm, 5 nm, 6 nm, 7 nm, 8 nm, 9 nm, 0.01 μm, 0.05 μm, 0.10 μm, 0.15 μm, 0.20 μm, 0.25 μm, 0.30 μm, 0.35 μm, 0.40 μm, 0.45 μm, 0.50 μm, 0.55 μm, 0.60 μm, 0.65 μm, 0.70 μm, 075 μm, 0.80 μm, 0.85 μm, 0.90 μm, or 0.95 μm to 1.0 μm, 1.5 μm, 2.0 μm, 2.5 μm, 3.0 μm, 3.5 μm, 4.0 μm, 4.5 μm, 5.0 μm, 5.5 μm, 6.0 μm, 6.5 μm, 7.0 μm, 7.5 μm, 8.0 μm, 8.5 μm, 9.0 μm, or 10 μm, more particularly from 0.01 μm, 0.05 μm, 0.10 μm, 0.15 μm, 0.20 μm, 0.25 μm, 0.30 μm, 0.35 μm, 0.40 μm, 0.45 μm, 0.50 μm to 0.55 μm, 0.60 μm, 0.65 μm, 0.70μm, 075 μm, 0.80 μm, 0.85 μm, 0.90 μm, 0.95 μm, 1.0 μm,1.5 μm, 2.0 μm, 2.5 μm, 3.0 μm, 3.5 μm, 4.0 μm, 4.5 μm, or 5.0 μm.

The porous carbon coating may be present in an amount of from 1 wt. % to 90 wt. % of the total weight of the coated sulfur particle. In particular embodiments, the porous carbon coating may be present in an amount of from 1.0 wt. %, 1.5 wt. %, 2.0 wt. %, 2.5 wt. %, 3.0 wt. %, 3.5 wt. %, 4.0 wt. %, 4.5 wt. %, or 5.0 wt. % to 5.5 wt. %, 6.0 wt. %, 6.5 wt. %, 7.0 wt. %, 7.5 wt. %, 8.0 wt. %, 8.5 wt. %, 9.0 wt. %, 9.5 wt. %, or 10 wt. % or more by total weight of the porous carbon coated sulfur particle, more particularly from 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, or 2.0 wt. % to 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, or 3.0 wt. % by total weight of the porous carbon coated sulfur particle.

The average pore size of the porous carbon coating may range from 1 nm or less. In specific embodiments, the porous carbon coating may have an average pore size of from 0.1 nm to 0.7 nm. In particular embodiments, the porous carbon coating may have an average pore size of from 0.1 nm, 0.15 nm, 0.2 nm, 0.25 nm, 0.3 nm, 3.5 nm, or 0.4 nm to 4.5 nm, 5.0 nm, 5.5 nm, 0.6 nm, 6.5 nm, 0.7 nm, 7.5 nm, 0.8 nm, 8.5 nm, 0.9 nm, 9.5 nm, or 1 nm. In certain embodiments, the porous carbon coating may have an average pore size of from 0.3 nm to 0.6 nm or less than 0.7 nm, from 0.3 nm to 0.7 nm, or from 0.4 nm to 0.6 nm or less than 0.6 nm.

In another method of forming the polymer coating, instead of polymerizing the coating in situ, pre-formed polymers, such as those polymers that may be prepared from the monomers previously discussed, are dissolved in a suitable solvent. These polymers may also include a dopant material, such as nitrogen, OH groups, COOH groups, etc., as previously described, that are present in the polymer chains. Examples of such polymers include polyurethane and polyurethane acrylates. Suitable solvents may include dimethyl sulfoxide (DMSO), dimethylformamide (DMF), dimethylacetamide (DMA). The solvent should be non-aqueous or substantially water free, wherein any water present is at such a limited level that it is not detrimental to the particle formation as described herein. Heating may facilitate dissolving of the polymer. Temperatures of from 60° C. to 200° C. may be suitable for this purpose.

The sulfur particles, such as those sulfur particles described previously, are then contacted with the dissolved polymer solution so that the dissolved polymer forms a continuous polymer coating that surrounds the sulfur particle, with the polymer coating having a uniform or nearly uniform thickness, such as those thicknesses previously described for the in situ prepared polymers. The solvent is then removed, such as through heating and/or vacuum evaporation techniques.

After separation from the solvent and drying, the polymer coated particles are then heated in an oxygen-free or substantially oxygen-free atmosphere to a temperature sufficient to fully carbonize the polymer coating to form a continuous porous carbon coating surrounding the sulfur particle, as was previously described. This continuous porous carbon coating may have the same uniform or nearly uniform thickness and the same average pore size as was described previously for the porous carbon coating prepared by the in situ polymerization.

Plasma or gamma radiation treatments made during or after the carbonization step to introduce N₂ or NH₃ or other gases containing desired functional groups into the carbon coating so that the carbon coating constitutes a doped carbon coating may also be used, as described earlier.

In still another method of forming a polymer coating used in forming the porous carbon coating, sulfur particles, such as those previously described, are soaked in a concentrated sulfuric acid solution. Furfuryl alcohol liquid is then added to this and the materials are heated as a suspension in liquid or in a gas stream with mixing or agitation to a sufficient temperature to polymerize the furfuryl alcohol to polyfurfuryl alcohol. Temperatures of from 130° C. to 170° C. may be suitable for this purpose. Additionally, dopants containing certain elements or functional groups that are incorporated into the polymer during the polymerization process to increase the electrical conductivity of the coating may also be used. These may include those compounds containing nitrogen, OH groups, COOH groups, etc.

The resulting polyfurfuryl alcohol provides a continuous polymer coating that surrounds the sulfur particle, with the polymer coating having a uniform or nearly uniform thickness, such as those previously described.

After separation from the solution and drying, the polyfurfurlyl-alcohol-coated particles may then be heated or carbonized in an oxygen-free or substantially oxygen-free atmosphere to a temperature sufficient to fully carbonize the polymer coating to form a continuous porous carbon coating surrounding the sulfur particle having a uniform or nearly uniform thickness and average pore size that is the same or similar to those that have been previously described with respect to the porous carbon coatings prepared by the other methods. Doping using plasma or gamma radiation during carbonization may be used with this method as well.

The porous carbon-containing sulfur materials of the present invention can be used in a variety of energy storage applications or devices (e.g., fuel cells, batteries, supercapacitors, electrochemical capacitors, lithium-ion battery cells or any other battery cell, system or pack technology). The term “energy storage device” can refer to any device that is capable of at least temporarily storing energy provided to the device and subsequently delivering the energy to a load. Furthermore, an energy storage device may include one or more devices connected in parallel or series in various configurations to obtain a desired storage capacity, output voltage, and/or output current. Such a combination of one or more devices may include one or more forms of stored energy. By way of example a lithium-sulfur battery can include the previously described porous-carbon-coated sulfur material (e.g., on or incorporated in an anode electrode and/or a cathode electrode). In another example, the energy storage device can also, or alternatively, include other technologies for storing energy, such as devices that store energy through performing chemical reactions (e.g., fuel cells), trapping electrical charge, storing electric fields (e.g., capacitors, variable capacitors, ultracapacitors, and the like), and/or storing kinetic energy (e.g., rotational energy in flywheels).

In a typical lithium-sulfide battery, the porous-carbon-coated sulfur material is incorporated into an electrode. This material may be present in amount of up to 90 wt. % of the electrode. The electrode will typically be the positive terminal or cathode of the battery. The battery will also include a negative terminal or anode and an electrolyte to facilitate the passage of ions between the terminals. As an example, the porous-carbon-coated sulfur material may undergo mixing, deposition onto a conductive substrate (or current collector) by spraying/coating, drying and then to be formed as cathode. This is then combined with an anode and electrolyte to make single cell. Based on the specific output requirements, stacks of these cells can be made to form a battery or energy storage device.

The porous-carbon-coated sulfur particles prepared as described above, when incorporated into the cathode of a lithium-sulfur battery, can be used to increase the life of the battery. Because continuous carbon coatings or shells surrounding the sulfur particle can be prepared that have an average particle size of less than 0.7 nm, the S₄^{m-}—S₈^{m-}polysulfide ions, which have a particle size of 0.7 nm or more, are prevented from migrating into the electrolyte solution and permanently deposited on the anode, thus reducing the life of the battery. Furthermore, as described previously, where fully lithiated sulfur particles are used to form the porous-carbon-coated sulfur particles to maximize the volume of the formed carbon coating or shell, the physical integrity of the electrode can be maintained during extreme volume changes during the charge-discharge cycles.

While the invention has been shown in some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. A sulfur-containing composition comprising:
a sulfur particle; and
a continuous porous carbon coating surrounding the sulfur particle, the porous carbon coating having a uniform or nearly uniform thickness of 1 nm to 10 μm and an average pore size 1 nm or less.

2. The composition of claim 1, wherein:
at least one of:
the sulfur particle comprises at least one of a metal sulfide, a metal polysulfide, and elemental sulfur; and
the sulfur particle comprises an electron conductor of at least one of a carbon nanotubes, carbon nanofibers, and graphene.

3. The composition of any of claims 1-2, wherein:
the sulfur particle has a particle size of from 0.001 micron to 10 microns.

4. The composition of any of claims 1-3, wherein:
the porous carbon coating has an average pore size of from 0.7 nm or less.

5. The composition of any of claims 1-3, wherein:
the porous carbon coating has an average pore size of from 0.1 nm to 0.7 nm.

6. The composition of any of claims 1-3, wherein:
the porous carbon coating has an average pore size of from 0.3 nm to 0.6 nm.

7. The composition of any of claims 1-6, wherein:
the porous carbon coating is present in an amount of from 1 wt. % to 90 wt. % of the total weight of the coated sulfur particle.

8. The composition of any of claims 1-7, wherein:
the porous carbon coating has a uniform or nearly uniform thickness of from 1 nm to 1 μm.

9. The composition of any of claims 1-8, wherein:
the porous-carbon-coated sulfur particle is incorporated into an energy storage device.

10. The composition of any of claims 1-9, wherein:
the porous carbon coating includes a dopant to increase the electrical conductivity of the porous carbon coating.

11. A method of forming a sulfur-containing composition, the method comprising:
contacting a sulfur particle with at least one of 1) a polymerizable monomer material under polymerization reaction conditions sufficient to form a continuous carbonizable polymer coating on the sulfur particle surface, and 2) a dissolved carbonizable polymer that forms a carbonizable polymer coating on the sulfur particle surface; and
carbonizing the carbonizable polymer coating to form a porous carbon coating surrounding the sulfur particle, the porous carbon coating having a uniform or nearly uniform thickness of 1 nm to 10 μm and an average pore size 1 nm or less.

12. The method of claim 11, wherein:
the sulfur particle comprises at least one of metal sulfide, metal polysulfide, and elemental sulfur.

13. The method of any of claims 11-12, wherein:
the porous carbon coating has an average pore size of from 0.1 nm to 0.7 nm.

14. The method of any of claims 11-13, wherein:
the porous carbon coating is present in an amount of from 1 to 90 wt. % of the total weight of the coated sulfur particle.

15. The method of any of claims 11-14, further comprising:
incorporating the porous-carbon-coated sulfur particle into an electrode for an energy storage device.

16. The method of any of claims 11-15, further comprising:
incorporating the porous-carbon-coated sulfur particle into an electrical energy storage device.

17. The method of any of claims 11-16, wherein: 4-vinylpyridine, divinylbenzene, vinylidene chloride, vinylidene fluoride, vinyl chloride, vinyl fluoride, styrene, methylmethoacrylate, aniline, epoxides, urethanes, acrylates, urethane acrylates, phthalates, ester-containing monomers, vinylpyrrolidone/divinylbenzene co-monomers, polyacrylonitrile, and furfuryl alcohol.

18. The method of any of claims 11-17, wherein:
the carbonizable polymer coating is doped to increase the electrical conductivity of the porous carbon coating during at least one of 1) the formation of the carbonizable polymer coating and 2) carbonizing the carbonizable polymer coating.

19. The method of any of claims 11-18, wherein:
the carbonizable polymer coating is carbonized in a substantially oxygen-free atmosphere to form a porous carbon coating surrounding the sulfur particle.

20. The method of any of claims 11-19, wherein:
the porous carbon coating has a uniform or nearly uniform thickness of from 1 nm to 1 μm.
